(19) United States
(12) Patent Application Publication
(10) Pub. No.: US 2026/0225913 A1
(43) Pub. Date: Aug. 6, 2026

(54) LITHIUM NICKEL-BASED COMPOSITE OXIDE AS A POSITIVE ELECTRODE ACTIVE MATERIAL FOR LITHIUM-ION RECHARGEABLE BATTERIES

(71) Applicant: Umicore, Brussels (BE)

(72) Inventors: KyeongSe SONG, Chungcheongnam-do (KR); Maxime BLANGERO, Chungcheongnam-do (KR); HeeSuk KU, Chungcheongnam-do (KR); Olesia KARAKULINA, Chungcheongnam-do (KR)

(21) Appl. No.: 19/123,617

(22) PCT Filed: Oct. 25, 2023
(86) PCT No.: PCT/EP2023/079709

§ 371 Date: Apr. 23, 2025

(30) Foreign Application Priority Data
Oct. 26, 2022 (EP) 22203759.0

(51) Int. Cl. C01G 53/506; H01M 4/02; H01M 4/525

(52) U.S. Cl. CPC C01G 53/506; H01M 4/525; C01P 2002/85; C01P 2004/04; C01P 2006/12; C01P 2006/40; H01M 2004/021; H01M 2004/028

(57) ABSTRACT

The present invention relates to a positive electrode active material for lithium-ion rechargeable batteries, wherein the positive electrode active material comprises Li and transition metals such as Ni, optionally Co, optionally Mn and Nb, wherein the positive electrode active material is coated with B, and wherein a specific surface area of said positive electrode active material is higher than or equal to 0.50 m2/g and lower than or equal to 1.50 m2/g.

### TECHNICAL FIELD AND BACKGROUND

The present invention relates to a positive electrode active material for lithium-ion rechargeable batteries. More specifically, the present invention relates to a positive electrode active material comprising lithium (Li), M′, and oxygen, wherein M′ includes niobium (Nb) and 80 at % or more of nickel (Ni). The positive electrode active material is coated with boron (B), and has a specific surface area. The present invention also relates to a method of manufacturing the positive electrode active material, a battery comprising the positive electrode active material, and use of a battery comprising the positive electrode active material in an electric vehicle or in a hybrid electric vehicle.

It is already known that a lithium-ion rechargeable battery comprising a Ni-rich (i.e., comprising more than 80 at % Ni) positive electrode active material has advantages of high specific energy capacity and high operating voltage. Furthermore, it is described in Yehonatan Levartovsky et al., ACS Appl. Mater. Interfaces 2021, 13, 34145-34156 that the electrode comprising a positive active electrode material, which has Nb and 85 at % of Ni, has a slightly higher initial discharge capacity (DQ1). However, FIG. 3 of CN 106505195 A shows an experimental result that the lithium ion battery comprising the positive electrode active material with Nb has high capacity fading. The capacity fading or capacity loss is a phenomenon observed in rechargeable battery usage where the amount of charge a battery can deliver at the rated voltage decreases with use. Although Nb is beneficial to a Ni-rich positive electrode active material in terms of DQ1, Nb is not preferable in terms of capacity fading. Furthermore, the increase of the evolved gas amount and the direct current resistance after the full cell test are not solved only by comprising Nb. Accordingly, there is a need for a Ni-rich positive electrode active material with Nb having low capacity fading, high DQ1 as well as the less evolved gas amount and the less direct current resistance after the full cell test.

It is a first object of the present invention to provide a positive electrode active material comprising Nb and 80 at % or more of Ni with improved electrochemical properties such as high DQ1 and low capacity fading.

It is a second object of the present invention to provide a method for manufacturing a the above-mentioned positive electrode active material.

It is a third object of the present invention to provide a battery comprising the positive electrode active material.

It is a fourth object of the present invention to provide a use of a battery comprising the positive electrode active material in an electric vehicle or in a hybrid electric vehicle.

### SUMMARY OF THE INVENTION

The 1^{st} object is achieved by providing a positive electrode active material for lithium-ion rechargeable batteries, wherein the positive electrode active material comprises Li, M′, and oxygen, wherein M′ comprises:
Ni in a content x, wherein x≥80.0 at %, relative to M′;
Co in a content y, wherein 0.0≤y≤20.0 at %, relative to M′;
Mn in a content z, wherein 0.0≤z≤20.0 at %, relative to M′;
D in a content a, wherein 0.0≤a≤5.0 at %, relative to M′, wherein D is at least one element selected from the group consisting of Ba, Ca, Cr, Fe, Mg, Mo, S, Si, Sr, Ti, Y, V, W, and Zn;
B in a content b, wherein 0.0<b≤4.0 at %, relative to M′;
Nb in a content c, wherein 0.0<c≤4.0 at %, relative to M′;
Al in a content d, wherein 0.0≤d≤4.0 at %, relative to M′; and
Zr in a content e, wherein 0.0≤e≤4.0 at %, relative to M′,
wherein x, y, z, a, b, c, d, and e are measured by ICP-OES,
wherein x+y+z+a+b+c+d+e is 100.0 at %,
   wherein the positive electrode active material has a B content B_{A} defined as b/(x+y+z+b+c+d+e), and wherein the positive electrode active material has a B content B_{B} wherein B_{B} is determined by XPS analysis and B_{B} is expressed as atomic content compared to the sum of atomic contents of Ni, Co, Mn, B, Nb, Al, and Zr as measured by XPS analysis, wherein a ratio B_{B}/B_{A}>10.0, and
   wherein a specific surface area of said positive electrode active material is higher than or equal to 0.50 m²/g and lower than or equal to 1.50 m²/g.

The 2^{nd} object is achieved by providing a method for manufacturing said positive electrode active material, wherein the method comprises the following consecutive steps of:
Step 1) mixing a lithium source and a transition metal composite precursor comprising Ni, optionally Co and optionally Mn with a Nb containing compound to obtain a first mixture;
Step 2) heating the first mixture at a temperature between 600° C. and 900° C. to obtain a first heated material;
Step 3) mixing the first heated material with water to obtain a slurry, filtering, and then drying said slurry to obtain a dried powder;
Step 4) mixing the dried powder with a B containing compound to obtain a second mixture; and
Step 5) heating the second mixture at a temperature between 250° C. and 500° C. so as to obtain the positive electrode active material powder.

The 3^{rd} object is achieved by providing a battery comprising said positive electrode active material.

The 4^{th} object is achieved by providing a use of said battery comprising said positive electrode active material in an electric vehicle or in a hybrid electric vehicle.

The positive electrode active material according to the present invention has an increased DQ1 and a lowered capacity fading when used in a lithium-ion rechargeable battery.

### BRIEF DESCRIPTION OF THE FIGURES

FIG. 1. XPS spectrum of B1s peak for EX2

FIG. 2. STEM-EDS line scanned graph for EX1 (A and B indicate the different primary particles respectively)

FIG. 3. DQ1 vs. the capacity fading of EX1, EX2, CEX1 to CEX6

### DETAILED DESCRIPTION

In the following detailed description, preferred embodiments are described in detail to enable practice of the present invention. Although the present invention is described with reference to these specific preferred embodiments, it will be understood that the present invention is not limited to these preferred embodiments. In contrast, the present invention includes numerous alternatives, modifications and equivalents as will become apparent from consideration of the following detailed description.

### Positive Electrode Active Material

In a first aspect, the present invention relates to a positive electrode active material for lithium-ion rechargeable batteries, wherein the positive electrode active material comprises Li, M′, and oxygen, wherein M′ comprises:
Ni in a content x, wherein x≥80.0 at %, relative to M′;
Co in a content y, wherein 0.0≤y≤20.0 at %, relative to M′;
Mn in a content z, wherein 0.0≤z≤20.0 at %, relative to M′;
D in a content a, wherein 0.0≤a≤5.0 at %, relative to M′, wherein D is at least one element selected from the group consisting of Ba, Ca, Cr, Fe, Mg, Mo, S, Si, Sr, Ti, Y, V, W, and Zn;
B in a content b, wherein 0.0<b≤4.0 at %, relative to M′;
Nb in a content c, wherein 0.0<c≤4.0 at %, relative to M′;
Al in a content d, wherein 0.0≤d≤4.0 at %, relative to M′; preferably wherein 0.0<d≤4.0 at %; and
Zr in a content e, wherein 0.0≤e≤4.0 at %, relative to M′,
wherein x, y, z, a, b, c, d, and e are measured by ICP-OES,
wherein x+y+z+a+b+c+d+e is 100.0 at %,
   wherein the positive electrode active material has a B content B_{A} defined as b/(x+y+z+b+c+d+e), and wherein the positive electrode active material has a B content B_{B} wherein B_{B} is determined by XPS analysis and B_{B} is expressed as atomic content compared to the sum of atomic contents of Ni, Co, Mn, B, Nb, Al, and Zr as measured by XPS analysis, wherein a ratio B_{B}/B_{A}>10.0, and
   wherein a specific surface area of said positive electrode active material is higher than or equal to 0.50 m²/g and lower than or equal to 1.50 m²/g.

In a preferred embodiment, x≥82.0 at %, preferably x≥84.0 at %, relative to M′.

In a preferred embodiment, x≤99.0 at %, preferably x≤97.0 at %, relative to M′.

In a preferred embodiment, y≥1.0 at %, preferably y≥1.5 at %, more preferably y≥2.0 at %, relative to M′.

In a preferred embodiment, y≤15.0 at %, preferably y≤13.0 at %, more preferably y≤10.0 at %, relative to M′.

In a preferred embodiment, z≥1.0 at %, preferably z≥1.5 at %, more preferably z≥2.0 at %, relative to M′.

In a preferred embodiment, z≤15.0 at %, preferably z≤13.0 at %, more preferably z≤10.0 at %, relative to M′.

In a preferred embodiment, 0.1≤a≤3.5 at %, preferably 0.1≤a≤2.5 at %, more preferably 0.1≤a≤1.0 at %, relative to M′.

In a preferred embodiment, 0.1≤b≤3.5 at %, preferably 0.1≤b≤2.5 at %, more preferably 0.1≤b≤1.5 at %, relative to M′.

In a preferred embodiment, 0.1≤c≤3.5 at %, preferably 0.1≤c≤2.5 at %, more preferably 0.1≤c≤1.0 at %, relative to M′.

In a preferred embodiment, 0.1≤d≤3.5 at %, preferably 0.1≤d≤2.0 at %, more preferably 0.1≤d≤1.0 at %, relative to M′.

In a preferred embodiment, 0.1≤e≤3.5 at %, preferably 0.1≤e≤2.0 at %, more preferably 0.1≤e≤1.0 at %, relative to M′.

In a preferred embodiment, the positive electrode active material is according to the following formula Li_{f}Niₓ₁Mn_{y1}Co_{z1}Dₐ₁B_{b1}Nb_{c1}Al_{d1}Zrₑ₁(O)₂, wherein
0.90≤f≤1.10, preferably 0.95≤f≤1.05, more preferably 0.98≤f≤1.02, most preferably f is about 1.00;
0.80≤x1≤0.99, preferably 0.82≤x1≤0.97, more preferably 0.84≤x1≤0.95, most preferably x1 is about 0.94;
0.00≤y1≤0.20, preferably 0.01≤y1≤0.15, more preferably 0.02≤y1≤0.13, most preferably y1 is about 0.03;
0.00≤z1≤0.20, preferably 0.01≤z1≤0.15, more preferably 0.02≤z1≤0.13, most preferably z1 is about 0.03;
0.000≤a1≤0.050, preferably 0.001≤a1≤0.035, more preferably 0.001≤a1≤0.010, most preferably a1 is about 0.000;
0.000<b1≤0.040, preferably 0.001≤b1≤0.035, more preferably 0.001≤b1≤0.010, most preferably b1 is about 0.010;
0.000<c1≤0.040, preferably 0.001≤c1≤0.035, more preferably 0.001≤c1≤0.010, most preferably c1 is about 0.005;
0.000<d1≤0.040, preferably 0.001≤d1≤0.035, more preferably 0.001≤d1≤0.010, most preferably d1 is about 0.006; and
0.000<e1≤0.040, preferably 0.001≤e1≤0.035, more preferably 0.001≤e1≤0.010, most preferably e1 is about 0.004,
wherein x1+y1+z1+a1+b1+c1+d1+e1=1.00.

In the framework of the present invention, at % signifies atomic percentage. The at % or “atomic percent” of a given element means a percentage of atoms of said element among all atoms in a claimed composition.

ICP-OES provides weight percent (wt %) of each element included in a material whose composition is determined by this technique. Conversion from wt % to at % is as follows: at % of a first element E₁ (Eₐₜ₁) in a material can be converted from a given wt % of said first element E₁ (E_{wt1}) in said material by applying the following formula,

$${E}_{a t 1} = \frac{( {E}_{w t 1} / {E}_{a w 1} )}{{\sum }_{i = 1}^{n} ( {E}_{w t i} / {E}_{a w i} )} \times 100 \% ,$$

wherein E_{aw1} is a standard atomic weight (molecular weight) of the first element E₁, E_{wti} is wt % of an i^{th} element Eᵢ, E_{awi} is a standard atomic weight (molecular weight) of said i^{th} element Eᵢ, and n is an integer which represents the number of types of all elements included in the material.

The inventors of the present invention have found that both the increased DQ1 and the lowered capacity fading of a lithium-ion rechargeable battery is achieved by the positive electrode active material according to the present invention. In detail, the inventors of the present invention have found that the lithium-ion rechargeable battery comprising the positive electrode active material according to the present invention, wherein the positive electrode active material comprises Nb and 80 at % or more of Ni, the positive electrode active material is coated with B, and the positive electrode active material has a specific surface area ranging from 0.50 m²/g to 1.50 m²/g, has an increased DQ1 and a lowered capacity fading.

B coating is determined by a ratio of B_{B}/B_{A}. If B_{B}/B_{A} exceeds 10.0, it is regarded that B coating is conducted. B_{A} and B_{B} are defined as an atomic content compared to the sum of atomic contents of Ni, Co, Mn, B, Nb, Al, and Zr, which is represented as below:

$$Atomic content of B ( {B}_{A} or {B}_{B} ) = \frac{B ( at \% )}{\begin{matrix}Ni ( at \% ) + Co ( at \% ) + Mn ( at \% ) + B ( at \% ) + \\ Nb ( at \% ) + Al ( at \% ) + Zr ( at \% )\end{matrix}}$$

Each content of Ni, Co, Mn, B, Nb, Al, and Zr in B_{A} is measured by ICP-OES and each content of Ni, Co, Mn, B, Nb, Al, and Zr in B_{B} is measured by XPS analysis.

Table 1 shows some symbols of positive electrode active materials to explain technical effects of the present invention.

TABLE 1
The meanings of CAM1, CAM2, CAM3 and CAM4

| Symbol | Meaning |
|---|---|
| CAM1 | A positive electrode active material prepared by the |
| | following process: |
| | mixing a Li source and a transition metal composite precursor |
| | comprising Ni, optionally Co and optionally Mn to obtain a |
| | first mixture; |
| | heating the first mixture at a temperature between 600° C. |
| | and 900° C. to obtain a first heated material; |
| | mixing the first heated material with an aqueous solution |
| | to obtain a slurry, filtering, and then drying said slurry to |
| | obtain a dried powder; and |
| | heating the dried powder at a temperature |
| | between 250° C. and 500° C. so as to obtain CAM1. |
| CAM2 | A positive electrode active material prepared by the same |
| | process as CAM1 except that the transition metal composite |
| | precursor further comprises Nb |
| CAM3 | A positive electrode active material prepared by the same |
| | process as CAM1 except that (i) the transition metal |
| | composite precursor further comprises Nb, and (ii) the dried |
| | powder is mixed with a B containing compound before being |
| | heated at a temperature between 250° C. and 500° C. |
| CAM4 | A positive electrode active material prepared by the same |
| | process as CAM1 except that the dried powder is mixed with |
| | a B containing compound before being heated at a temperature |
| | between 250° C. and 500° C. |

The inventors of the present invention have found that DQ1 of a lithium-ion rechargeable battery comprising CAM1 is lower than that of a lithium-ion rechargeable battery comprising CAM2, but the capacity fading of CAM2 is much higher than that of CAM1. That is, when Nb is further included in the transition metal composite precursors of CAM1, DQ1 is improved, but the capacity fading is much worsened. The inventors of the present invention have also found that the capacity fading of CAM3 is much lower than that of CAM2, and DQ1 of CAM3 is higher than that of CAM2. That is, when B coating layer is formed on CAM2, DQ1 and the capacity fading are improved altogether. Furthermore, the inventors of the present invention have found the capacity fading of CAM3 is similar or inferior to that of a lithium-ion rechargeable battery comprising CAM4. It is surprising that, as for a positive electrode active material prepared by the process comprising mixing a heated material obtained by heating a mixture comprising a Li source and a transition metal composite precursor with an aqueous solution, when Nb presence and B coating are combined, the capacity fading and DQ1 are improved altogether even though the capacity fading of the lithium-ion rechargeable battery comprising CAM2, wherein only Nb presence is conducted, is worsened.

The inventors of the present invention have also found that the direct current resistance and the evolved gas amount generated by the reaction between the charged positive electrode and the electrolyte after the full cell test are improved altogether if a positive electrode active material comprises Al, Nb, B coating and BET ranging from 0.50 m²/g to 1.50 m²/g, which may be obtained by mixing a lithiated transition metal composite material with an aqueous solution.

In a preferred embodiment, the positive electrode active material may not comprise Zr, i.e. e=0.0 at %, relative to M′. DQ1 and the capacity fading of a lithium-ion rechargeable battery comprising a positive electrode active material, wherein Zr is not included in CAM3, may be improved as compared to those of a lithium-ion rechargeable battery comprising a positive electrode active material, wherein Zr is included in CAM3.

In a preferred embodiment, the ratio B_{B}/B_{A} may be at least 35.0, preferably at least 50.0, and more preferably at least 70.0.

In a preferred embodiment, the ratio B_{B}/B_{A} is lower than or equal to 300.0, since a positive electrode active material having a B_{B}/B_{A} higher than 300.0 would have a DQ1 lower than that of the positive electrode active material in this invention.

In a preferred embodiment, the specific surface area of the positive electrode active material may be between 0.60 m²/g and 1.40 m²/g, and preferably between 0.65 m²/g and 1.35 m²/g.

In a preferred embodiment, the positive electrode active material comprises at least 100 ppm and at most 500 ppm carbon content as measured by carbon combustion method.

In a preferred embodiment, the positive electrode active material comprises at least one primary particle, and a concentration of Nb, relative to the sum of atomic contents of Ni, Mn, Co, and Nb, on a surface of the primary particle is higher than a concentration of Nb, relative to the sum of atomic contents of Ni, Mn, Co, and Nb, at a center of the primary particle as measured by cross section TEM-EDS analysis. The cross section has an outer boundary of the primary particle which is also referred to as “surface.” A center of the primary particle is a mid-point of a straight line through the cross section, which is the longest among the straight lines formed by connecting any two points on the surface of the primary particle. If the concentration of Nb on the surface of the primary particle is higher than the concentration of Nb at the center of the primary particle, Li ions move faster on the surface of the primary particle due to high Li conductivity caused by Nb enrichment on the surface, and thus, the capacity of a lithium-ion rechargeable battery is increased.

### Method for Manufacturing Positive Electrode Active Material

In a second aspect, the present invention relates to method for manufacturing the positive electrode active material according to the first aspect, wherein the method comprises the following consecutive steps of:
Step 1) mixing a Li source and a transition metal composite precursor comprising Ni, optionally Co and optionally Mn with a Nb containing compound to obtain a first mixture;
Step 2) heating the first mixture at a temperature between 600° C. and 900° C. to obtain a first heated material;
Step 3) mixing the first heated material with water to obtain a slurry, filtering, and then drying said slurry to obtain a dried powder;
Step 4) mixing the dried powder with a B containing compound to obtain a second mixture; and
Step 5) heating the second mixture at a temperature between 250° C. and 500° C. so as to obtain the positive electrode active material powder.

In a preferred embodiment, the second mixture is heated at a temperature between 250° C. and 450° C.

In a preferred embodiment, the Nb containing compound in Step 1) is at least one selected from the group consisting of niobium acid, niobium oxide, and lithium niobium oxide.

In a preferred embodiment, the B containing compound in Step 4) is at least one selected from the group consisting of boric acid, boron oxide, and lithium boron oxide.

The positive electrode active material according to the first aspect of the present invention is obtained by a process according to the second aspect of the present invention. In detail, the technical features of the first aspect of the present invention, e.g., the specific composition of the positive electrode active material, B_{B}/B_{A}>10.0, the specific surface area ranging from 0.50 m²/g to 1.50 m²/g, and the carbon content ranging from 100 ppm to 500 ppm are achieved by the process according to the second aspect of the present invention.

### Battery

In a third aspect, the present invention relates to a battery comprising the positive electrode active material according to the first aspect.

### Use of Battery

In a fourth aspect, the present invention relates to a use of the battery according to the third aspect.

As appreciated by a person skilled in the art, all embodiments directed to the positive electrode active material according to the first aspect may apply mutatis mutandis to the second, third and fourth aspects.

### EXPERIMENTAL ANALYSIS USED IN THE EXAMPLES

The following analysis methods are used in the Examples.

### A) Inductively Coupled Plasma Optical Emission Spectrometry (ICP-OES) Measurement

The amount of Li, Ni, Co, Mn, B, Nb, Al, and Zr in the positive electrode active material powder is measured with the inductively coupled plasma-optical emission spectrometry (ICP-OES) method by using an Agilent ICP 720-ES (Agilent Technologies). 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 ml mark, followed by complete homogenization.

### B) Specific Surface Area Analysis

The specific surface area of the positive electrode active material is measured with the Bruanauer-Emmett-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

### C) Carbon Analysis

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 grams of tungsten and 0.2 grams of tin are added into the crucible as accelerators. The powder is heated at a programmable temperature wherein gases produced during the combustion are then analyzed by Infrared detectors. The analysis of CO₂ and CO determines the carbon concentration.

### D) X-Ray Photoelectron Spectroscopy (XPS) Measurement

The surface of the positive electrode active material is analyzed by using X-ray photoelectron spectroscopy (XPS). In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer (Thermo Scientific, https://www.thermofisher.com/order/catalog/product/IQLAADGAAFFACVMAHV).

Monochromatic Al Kα radiation (hv=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow-scans are performed afterwards at 50 eV for at least 10 scans for each identified element to determine the precise surface composition.

Curve fitting is done with CasaXPS Version2.3.19PR1.0 (Casa Software, http://www.casaxps.com/) using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 2a
XPS fitting parameter for Ni2p, Mn2p,
Co2p, Al2p, B1s, Nb3d, and Zr3d.

| | Sensi- | | | |
|---|---|---|---|---|
| | tivity | Fitting range | Defined | Line |
| Element | factor | (eV) | peak(s) | shape |
| Ni | 14.61 | 851.1 ± 0.1- | Ni2p3, Ni2p3 satellite | LA(1.33, |
| | | 869.4 ± 0.1 | | 2.44, 69) |
| Mn | 9.17 | 639.9 ± 0.1- | Mn2p3, Mn2p3 satellite | GL(30) |
| | | 649.5 ± 0.1 | | |
| Co | 12.62 | 775.4 ± 0.1- | Co2p3-1, Co2p3-2, Co2p3 | GL(30) |
| | | 792.7 ± 0.3 | satellite | |
| Al | 0.54 | 78.5 ± 0.1- | Al2p peak 1, Al2p peak 2, | GL(30) |
| | | 64.1 ± 0.1 | Al2p peak 3, Ni3p1, Ni3p3, | |
| | | | Ni3p1 satellite, Ni3p3 | |
| | | | satellite | |
| B | 0.49 | 186.0 ± 0.1- | B1s peak 1, B1s peak 2 | GL(30) |
| | | 196.3 ± 0.1 | | |
| Nb | 8.21 | 204.5 ± 0.1- | Nb3d peak 1, Nb3d peak 2 | GL(30) |
| | | 212.0 ± 0.1 | | |
| Zr | 7.04 | 178.0 ± 0.1- | Zr3d peak 1, Zr3d peak 2 | GL(30) |
| | | 188.5 ± 0.1 | | |

For Al, Mn and Co peaks, constraints are set for each defined peak according to Table 2b. All Ni3p peaks related including Ni3p3, Ni3p1, Ni3p3 satellite, and Ni3p1 satellite are not quantified.

TABLE 2b
XPS fitting Constraints for Al2p, Mn2p, Co2p, and Nb3d.

| | | Fitting range | FWHM | |
|---|---|---|---|---|
| | Defined | constraint | constraint | Area |
| Element | peak | (eV) | (eV) | constraint |
| Al | Ni3p3 | 65.7-68.0 | 0.5-2.9 | No constraint set |
| | Ni3p1 | 68.0-70.5 | 0.5-2.9 | 50% of Ni3p3 area |
| | Ni3p3 satellite | 70.5-72.5 | 0.5-2.9 | 40% of Ni3p3 area |
| | Ni3p1 satellite | 72.5-75.0 | 0.5-2.9 | 20% of Ni3p3 area |
| | Al2p | 72.6-74.7 | 0.5-3.0 | No constraint set |
| Mn | Mn2p3 peak 1 | 640-642 | 0.1-3.5 | No constraint set |
| | Mn2p3 peak 1 | 642-644 | 0.1-3.5 | No constraint set |
| | Mn2p3 peak 2 | 644-646 | 0.1-3.5 | 40% of Mn2p3 |
| | satellite | | | peak 1 area |
| | Mn2p3 peak 2 | 645-650 | 0.1-3.5 | 40% of Mn2p3 |
| | satellite | | | peak 2 area |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-6.0 | No constraint set |
| Nb | Nb 3d5 | 204.5-208.5 | 0.3-7.5 | No constraint set |
| | Nb 3d3 | 208.5-212.0 | 0.3-7.5 | 66.7% of Nb3d5 |
| | | | | area |

The B surface contents (B_{B}) as determined by XPS is expressed as a atomic content of B in the surface layer of the particles divided by the total content of Ni, Co, Mn, B, Nb, Al, and Zr in said surface layer. It is calculated as follow:

$${B}_{B} = \frac{B ( at \% )}{\begin{matrix}Ni ( at \% ) + Co ( at \% ) + Mn ( at \% ) + B ( at \% ) + \\ Nb ( at \% ) + Al ( at \% ) + Zr ( at \% )\end{matrix}}$$

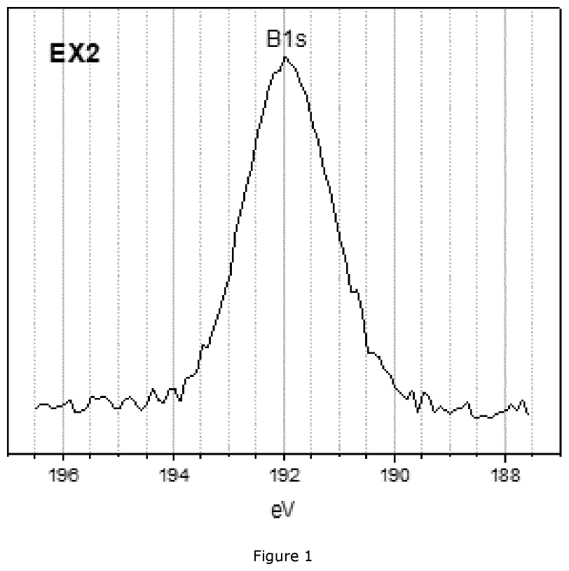

The information of XPS peak position can be easily obtained in the regions and components report specification after fitting is conducted. XPS graph of B for EX2 is shown in FIG. 1.

### E) Scanning Transmission Electron Microscopy (STEM) and Energy Dispersive X-Ray Spectroscopy (EDS) Measurement

The electron microscopic images were measured with the Scanning Transmission Electron Microscopy (STEM) and Energy Dispersive X-ray Spectroscopy (EDS) after making a lamella from a particle by using a Thermo Fisher Helios FIB-SEM so as to obtain the cross-sectional image. The High Angle Annular Dark Field Scanning Transmission Electron Microscopy (HAADF-STEM) and Energy Dispersive X-ray spectroscopy (EDS) were performed on an aberration corrected FER Titan transmission electron microscope at 300 kV, using a Super X detector.

### F) Coin Cell Testing

### F-1) Coin Cell Preparation

For the preparation of a positive electrode, a slurry that contains a positive electrode active material powder, conductor (Super P, Timcal), binder (KF #9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### F-2) Testing Method

The testing method is a conventional “constant cut-off voltage” test. The conventional coin cell test in the present invention follows the schedule shown in Table 3. Each cell is cycled at 25° C. using a Toscat-3100 computer-controlled galvanostatic cycling station (from Toyo).

The schedule uses a 1 C current definition of 220 mA/g in the 4.3 V to 3.0 V/Li metal window range. The capacity fading rate (QF) is obtained according to below an equation below wherein DQ1 is the discharge capacity at the first cycle.

$$QF ( \% / 100 cycles ) = 100 \times ( 1 - \frac{D {Q}_{34}}{D {Q}_{7}} ) \times \frac{1}{27} \times 100$$

TABLE 3
Cycling schedule for coin cell testing method

| | Charge | | | | Discharge | | | |
|---|---|---|---|---|---|---|---|---|
| | | End | | V/Li | | End | | V/Li |
| | | current | Rest | metal | | current | Rest | metal |
| Cycle | C Rate | (C) | (min) | (V) | C Rate | (C) | (min) | (V) |
| 1 | 0.1 | — | 30 | 4.3 | 0.1 | — | 30 | 3.0 |
| 2 | 0.25 | 0.05 | 10 | 4.3 | 0.20 | — | 10 | 3.0 |
| 3 | 0.25 | 0.05 | 10 | 4.3 | 0.50 | — | 10 | 3.0 |
| 4 | 0.25 | 0.05 | 10 | 4.3 | 1.00 | — | 10 | 3.0 |
| 5 | 0.25 | 0.05 | 10 | 4.3 | 2.00 | — | 10 | 3.0 |
| 6 | 0.25 | 0.05 | 10 | 4.3 | 3.00 | — | 10 | 3.0 |
| 7 | 0.25 | 0.1 | 10 | 4.3 | 0.10 | — | 10 | 3.0 |
| 8 | 0.25 | 0.1 | 10 | 4.3 | 1.00 | — | 10 | 3.0 |
| 9-33 | 0.50 | 0.1 | 10 | 4.3 | 1.00 | — | 10 | 3.0 |
| 34 | 0.25 | 0.1 | 10 | 4.3 | 0.10 | — | 10 | 3.0 |
| 35 | 0.25 | 0.1 | 10 | 4.3 | 1.00 | — | 10 | 3.0 |

### G) Full Cell Testing

### G-1) Full Cell Preparation

2000 mAh pouch-type cells are prepared as follows: the positive electrode active material powder, Super-P (Super-P, Imerys Graphite & Carbon) as positive electrode conductive agents, and polyvinylidene fluoride (PVDF S5130, Solvay) as a positive electrode binder are added to N-methyl-2-pyrrolidone (NMP) as a dispersion medium so that the mass ratio of the positive electrode active material powder, the positive electrode conductive agents: super P: positive electrode binder is set at 95:3:2, wherein the positive electrode active material powder is a mixture of 70 wt. % of CEX7 or EX2 with 30 wt. % of a single-crystalline lithium transition metal oxide having D50 of 3.7 μm comprising Ni, Mn, and Co in an atomic ratio of 88:5:7 comprising Al, B, W, and Zr. Thereafter, the mixture is kneaded to prepare a positive electrode mixture slurry. The resulting positive electrode mixture slurry is then applied onto both sides of a positive electrode current collector, made of a 20 μm thick aluminum foil. The width of the applied area is 88.5 mm and the length is 425 mm. Typical loading weight of a positive electrode active material is about 14.8±1 mg/cm². The electrode is then dried and calendared using a pressure of 4.5 MPa. In addition, an aluminum plate serving as a positive electrode current collector tab is arc-welded to an end portion of the positive electrode.

Commercially available negative electrodes are used. In short, a mixture of artificial graphite, carbon (Super P (Imerys)), carboxy-methyl-cellulose-sodium, and styrene-butadiene-rubber, in a mass ratio of 95.0/1/1.5/2.5, is applied on both sides of a copper foil. A nickel plate serving as a negative electrode current collector tab is arc-welded to an end portion of the negative electrode. Typical loading weight of a negative electrode active material is about 10±1 mg/cm².

Non-aqueous electrolyte is obtained by dissolving lithium hexafluorophosphate (LiPF₆) salt at a concentration of 1.2 mol/L in a mixed solvent of ethylene carbonate (EC), ethyl methyl carbonate (EMC), and diethyl carbonate (DEC) in a volume ratio of 1:1:1. It contains 1.0 wt. % lithium difluorophosphate (LiPO₂F₂), and 1.0 wt. % vinylene carbonate (VC) as additives.

A sheet of the positive electrode, a sheet of the negative electrode, and a sheet of the microporous polymer separator (13 μm) interposed between them are spirally wound using a winding core rod in order to obtain a spirally wound electrode assembly. The assembly and the electrolyte are then put in an aluminum laminated pouch in an air-dry room with dew point of −50° C., so that a flat pouch-type lithium secondary battery is prepared. The design capacity of the secondary battery is 2000 mAh when charged to 4.20 V. The full cell testing procedure uses a 1 C current definition of 2000 mA/g.

### G-2) Cycle Life Test

### A. Pre-Charging and Formation

The non-aqueous electrolyte solution is impregnated into the prepared dry battery for 8 hours at room temperature. The battery is pre-charged with the current of 0.25 C until 14% of its theoretical capacity and aged for a day at room temperature. The battery is then degassed using a pressure of −760 mmHg for 30 seconds, and the aluminum pouch is sealed. During measurement, the pouch is assembled in a press jig provided with silicon pad.

The battery is charged with a current of 0.2 C in CC mode (constant current) up to 4.2 V and CV mode (constant voltage) until a cut-off current of C/20 is reached. The battery is discharged with a current of 0.2 C in CC mode down to 2.7 V. Then, it is fully charged with a current of 0.50 C in CC mode up to 4.2 V and CV mode until a cut-off current of C/20 is reached.

Afterwards, cell is discharged with a current of 0.50 C in CC mode down to 2.7 V. It is again charged with a current of 0.5 C in CC mode up to 4.2 V and CV mode until a cut-off current of C/20 is reached. The final charging step is done in 25° C.

### B. Bulging Test

2000 mAh pouch-type batteries prepared by above preparation method are fully charged until 4.2V and inserted in an oven which is heated to 90° C., then stays for 20 hours. At 90° C., the charged positive electrode reacts with an electrolyte and creates gas. The evolved gas creates a bulging. The increase of thickness ((thickness after storage-thickness before storage)/thickness before storage*100%) is measured after 20 hours.

C. Cycle life test

The lithium secondary full cell batteries are charged and discharged continuously under the following conditions at 45° C., to determine their charge-discharge cycle performance:
Charge is performed in CC mode under 1 C rate up to 4.2 V, then CV mode until C/20 is reached,
The cell is then set to rest for 10 minutes,
Discharge is done in CC mode at 1 C rate down to 2.7 V,
The cell is then set to rest for 10 minutes,
The charge-discharge cycles proceed until 600 cycles. Every 100 cycles, the discharge is done at 0.1 C rate in CC mode down to 2.7 V.

The internal resistance or direct current resistance (DCR) is measured at 1.5 C for 10 s at the beginning of every 100 cycles repetition and the end of 600^{th} cycles.

### EXAMPLES

The present invention is further illustrated in the following examples.

### Example 1

A positive electrode active material EX1 is obtained through following steps:
1) Preparing a first mixture: 274.0 grams of LiOH, 3.0 grams of Al₂O₃, 7.0 grams of Nb₂O₅ and 1.0 kilograms of Ni_{0.94}Mn_{0.03}Co_{0.03}(OH)₂ are mixed homogeneously to obtain a first mixture.
2) First heating: the first mixture obtained from step 1) is heated in an oxygen atmosphere at 740° C. for 12 hours to obtain a first heated material.
3) Preparing a slurry and drying: the first heated material is mixed with 5 liters of deionized water and stirred for 10 minutes. After stirring, the mixture is filtered to prepare a cake, and then the slurry is dried at 140° C. for 10 hours under vacuum atmosphere.
4) Preparing a second mixture: 1.0 kilograms of the dried material is mixed with 6.0 grams of H₃BO₃ homogeneously to obtain a second mixture.
5) Second heating: the second mixture obtained from step 4) is heated at 300° C. for 8 hours under an oxygen atmosphere and cooled to room temperature so as to obtain a positive electrode active material EX1.

### Comparative Example 1

A positive electrode active material CEX1 is obtained through following steps:
1) Preparing a first mixture: 272.0 grams of LiOH, 3.0 grams of Al₂O₃, and 1.0 kilograms of Ni_{0.94}Mn_{0.03}Co_{0.03}(OH)₂ are mixed homogeneously to obtain a first mixture.
2) First heating: The first mixture obtained from step 1) is heated in an oxygen atmosphere at 720° C. for 12 hours and cooled to room temperature to obtain a first heated material.
3) Preparing a slurry and drying: The first heated material is mixed with 5 liters of deionized water and stirred for 10 minutes. After stirring, the mixture is filtered to prepare a cake, and then the slurry is dried at 140° C. for 10 hours under vacuum atmosphere.
4) Second heating: The dried material obtained from step 3) is heated at 300° C. for 8 hours under an oxygen atmosphere and cooled to room temperature so as to obtain a positive electrode active material CEX1.

### Comparative Example 2

A positive electrode active material CEX2 is obtained through following steps:
1) Preparing a first mixture: 272.0 grams of LiOH, 3.0 grams of Al₂O₃, and 1.0 kilograms of Ni_{0.94}Mn_{0.03}Co_{0.03}(OH)₂ are mixed homogeneously to obtain a first mixture.
2) First heating: The first mixture obtained from step 1) is heated in an oxygen atmosphere at 720° C. for 12 hours and cooled to room temperature to obtain a first heated material.
3) Preparing a slurry and drying: The first heated material is mixed with 5 liters of deionized water and stirred for 10 minutes. After stirring, the mixture is filtered to prepare a cake, and then the slurry is dried at 140° C. for 10 hours under vacuum atmosphere.
4) Preparing a second mixture: 1.0 kilograms of the dried material is mixed with 6.0 grams of H₃BO₃ homogeneously to obtain a second mixture.
5) Second heating: The second mixture obtained from step 4) is heated at 300° C. for 8 hours under an oxygen atmosphere and cooled to room temperature so as to obtain a positive electrode active material CEX2.

### Comparative Example 3

A positive electrode active material CEX3 is obtained through following steps:
1) Preparing a first mixture: 274.0 grams of LiOH, 3.0 grams of Al₂O₃, 7.0 grams of Nb₂O₅, and 1.0 kilograms of Ni_{0.94}Mn_{0.03}Co_{0.03}(OH)₂ are mixed homogeneously to obtain a first mixture.
2) First heating: The first mixture obtained from step 1) is heated in an oxygen atmosphere at 740° C. for 12 hours and cooled to room temperature to obtain a first heated material.
3) Preparing a slurry and drying: The first heated material is mixed with 5 liters of deionized water and stirred for 10 minutes. After stirring, the mixture is filtered to prepare a cake, and then the slurry is dried at 140° C. for 10 hours under vacuum atmosphere.
4) Second heating: The dried material obtained from step 3) is heated at 300° C. for 8 hours under an oxygen atmosphere and cooled to room temperature so as to obtain a positive electrode active material CEX3.

### Example 2

A positive electrode active material EX2 is obtained through following steps:
1) Preparing a first mixture: 274.0 grams of LiOH, 3.0 grams of Al₂O₃, 7.0 grams of Nb₂O₅, 10.0 grams of ZrO₂ and 1.0 kilograms of Ni_{0.94}Mn_{0.03}Co_{0.03}(OH)₂ are mixed homogeneously to obtain a first mixture.
2) First heating: the first mixture obtained from step 1) is heated in an oxygen atmosphere at 740° C. for 12 hours and cooled to room temperature to obtain a first heated material.
3) Preparing a slurry and drying: the first heated material is mixed with 5 liters of deionized water and stirred for 10 minutes. After stirring, the mixture is filtered to prepare a cake, and then the slurry is dried at 140° C. for 10 hours under vacuum atmosphere.
4) Preparing a second mixture: 1.0 kilograms of the dried material is mixed with 6.0 grams of H₃BO₃ homogeneously to obtain a second mixture.
5) Second heating: the second mixture obtained from step 4) is heated at 300° C. for 8 hours under an oxygen atmosphere and cooled to room temperature so as to obtain a positive electrode active material EX2.

### Comparative Example 4

A positive electrode active material CEX4 is obtained through following steps:
1) Preparing a first mixture: 272.0 grams of LiOH, 3.0 grams of Al₂O₃, 10.0 grams of ZrO₂ and 1.0 kilograms of Ni_{0.94}Mn_{0.03}Co_{0.03}(OH)₂ are mixed homogeneously to obtain a first mixture.
2) First heating: The first mixture obtained from step 1) is heated in an oxygen atmosphere at 745° C. for 12 hours and cooled to room temperature to obtain a first heated material.
3) Preparing a slurry and drying: The first heated material is mixed with 5 liters of deionized water and stirred for 10 minutes. After stirring, the mixture is filtered to prepare a cake, and then the slurry is dried at 140° C. for 12 hours under vacuum atmosphere.
4) Second heating: The dried material obtained from step 3) is heated at 300° C. for 8 hours under an oxygen atmosphere and cooled to room temperature so as to obtain a positive electrode active material CEX4.

### Comparative Example 5

A positive electrode active material CEX5 is obtained through following steps:
1) Preparing a first mixture: 272.0 grams of LiOH, 3.0 grams of Al₂O₃, 10.0 grams of ZrO₂ and 1.0 kilograms of Ni_{0.94}Mn_{0.03}Co_{0.03}(OH)₂ are mixed homogeneously to obtain a first mixture.
2) First heating: the first mixture obtained from step 1) is heated in an oxygen atmosphere at 715° C. for 12 hours and cooled to room temperature to obtain a first heated material.
3) Preparing a slurry and drying: the first heated material is mixed with 5 liters of deionized water and stirred for 10 minutes. After stirring, the mixture is filtered to prepare a cake, and then the slurry is dried at 140° C. for 10 hours under vacuum atmosphere.
4) Preparing a second mixture: 1.0 kilograms of the dried material is mixed with 6.0 grams of H₃BO₃ homogeneously to obtain a second mixture.
5) Second heating: the second mixture obtained from step 4) is heated at 300° C. for 8 hours under an oxygen atmosphere and cooled to room temperature so as to obtain a positive electrode active material CEX5.

### Comparative Example 6

A positive electrode active material CEX6 is obtained through following steps:
1) Preparing a first mixture: 272.0 grams of LiOH, 3.0 grams of Al₂O₃, 7.0 grams of Nb₂O₅, and 10.0 grams of ZrO₂ and 1.0 kilograms of Ni_{0.94}Mn_{0.03}Co_{0.03}(OH)₂ are mixed homogeneously to obtain a first mixture.
2) First heating: the first mixture obtained from step 1) is heated in an oxygen atmosphere at 740° C. for 12 hours and cooled to room temperature to obtain a first heated material.
3) Preparing a slurry and drying: the first heated material is mixed with 5 liters of deionized water and stirred for 10 minutes. After stirring, the mixture is filtered to prepare a cake, and then the slurry is dried at 140° C. for 10 hours under vacuum atmosphere.
4) Second heating: The dried material obtained from step 3) is heated at 300° C. for 8 hours under an oxygen atmosphere and cooled to room temperature so as to obtain a positive electrode active material CEX6.

### Comparative Example 7

A positive electrode active material CEX7 is obtained through following steps:
1) Preparing a first mixture: 272.0 grams of LiOH, 7.0 grams of Nb₂O₅, and 10.0 grams of ZrO₂ and 1.0 kilograms of Ni_{0.92}Mn_{0.03}Co_{0.05}(OH)₂ are mixed homogeneously to obtain a first mixture.
2) First heating: the first mixture obtained from step 1) is heated in an oxygen atmosphere at 770° C. for 12 hours and cooled to room temperature to obtain a first heated material.
3) Preparing a slurry and drying: the first heated material is mixed with 5 liters of deionized water and stirred for 10 minutes. After stirring, the mixture is filtered to prepare a cake, and then the slurry is dried at 140° C. for 10 hours under vacuum atmosphere.
4) Preparing a second mixture: 1.0 kilograms of the dried material is mixed with 6.0 grams of H₃BO₃ homogeneously to obtain a second mixture.
5) Second heating: the second mixture obtained from step 4) is heated at 300° C. for 8 hours under an oxygen atmosphere and cooled to room temperature so as to obtain a positive electrode active material CEX7.

TABLE 4
A summary of the chemical properties for the examples and
the comparative examples such as ICP-OES and BET results

| Example | Composition* (at %) | | | | | | | SSA |
|---|---|---|---|---|---|---|---|---|
| ID | Ni (x) | Co (y) | Mn (z) | Al (d) | B (b) | Nb (c) | Zr (e) | (m²/g) |
| EX1 | 92.40 | 2.88 | 2.85 | 0.54 | 0.82 | 0.51 | 0.00 | 0.77 |
| CEX1 | 93.67 | 2.97 | 2.90 | 0.45 | 0.00 | 0.00 | 0.00 | 1.13 |
| CEX2 | 92.87 | 2.95 | 2.86 | 0.45 | 0.86 | 0.00 | 0.00 | 0.52 |
| CEX3 | 93.09 | 2.91 | 2.89 | 0.62 | 0.00 | 0.50 | 0.00 | 1.58 |
| EX2 | 91.88 | 2.86 | 2.83 | 0.55 | 1.02 | 0.51 | 0.36 | 0.70 |
| CEX4 | 93.28 | 2.94 | 2.89 | 0.53 | 0.00 | 0.00 | 0.37 | 1.06 |
| CEX5 | 92.48 | 2.90 | 2.89 | 0.59 | 0.82 | 0.00 | 0.33 | 0.57 |
| CEX6 | 92.82 | 2.90 | 2.87 | 0.54 | 0.00 | 0.52 | 0.35 | 1.50 |
| CEX7 | 90.54 | 2.99 | 4.86 | 0.00 | 0.84 | 0.48 | 0.29 | 0.67 |

*Composition relative to total atomic contents of Ni, Co, Mn, Al, B, Nb, and Zr

Table 4 summarizes the chemical properties for the examples and the comparative examples such as the composition analyzed by ICP-OES and the specific surface area (SSA) analyzed by BET method.

TABLE 5
A summary of B_{B}/B_{A} ratio, carbon contents and the electrochemical
properties for the examples and the comparative examples

| | | | | Electrochemical property | |
|---|---|---|---|---|---|
| | | | | | Capacity |
| Example | | | C | DQ1 | fading rate |
| ID | B_{B} | B_{B}/B_{A}** | (ppm) | (mAh/g) | (%/100cycle) |
| EX1 | 0.6180 | 75.37 | 151 | 230.9 | 16.5 |
| CEX1 | n/a*** | n/a | 266 | 209.9 | 28.1 |
| CEX2 | n/a | n/a | 137 | 224.7 | 20.0 |
| CEX3 | n/a | n/a | 244 | 228.7 | 41.2 |
| EX2 | 0.3880 | 38.04 | 183 | 229.7 | 20.7 |
| CEX4 | n/a | n/a | 175 | 205.1 | 43.9 |
| CEX5 | 0.7140 | 87.07 | 197 | 226.2 | 20.4 |
| CEX6 | n/a | n/a | 209 | 225.4 | 45.3 |
| CEX7 | n/a | n/a | n/a | 231.4 | 17.6 |

**B_{A} is the atomic content of B calculated from Table 4 and B_{B} is the atomic content of B relative to total atomic contents of Ni, Mn, Co, Al, B, Nb, and Zr analyzed by XPS
***n/a: not applicable

Table 5 summarizes the B_{B}/B_{A} ratio, carbon contents, and the electrochemical properties such as DQ1 and capacity fading.

In Table 5, the XPS analysis results of B (B_{B}) are compared with the ICP-OES results of B (B_{A}) for EX1, EX2, and CEX5. The B_{B} result higher than 0 indicates that said B is present on the surface of the positive electrode active material as associated with the XPS measurement whose signal is acquired from the first few nanometers (e.g. 1 nm to 10 nm) of the uppermost part of a sample. On the other hand, B_{A} calculated with ICP-OES results is the B content of the entire particle. Therefore, the ratio of XPS result to ICP-OES result such as B_{B}/B_{A} higher than 1 indicates that said B is present mostly on the surface of the positive electrode active material. The higher B_{B}/B_{A} value corresponds with the more B presence on the surface of positive electrode active material. B_{B}/B_{A} values in EX1, EX2, and CEX5 are all higher than 10.0, which confirm the B presence on the surface of the particle according to this invention. The representative of XPS spectra showing B1s peak of EX2 is FIG. 1.

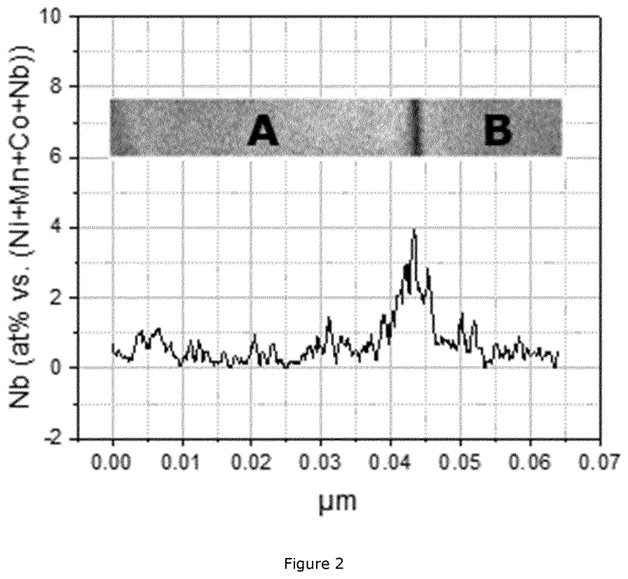

FIG. 2 is a STEM-EDS line scanned graph between the surfaces of two primary particles for EX1, wherein A and B indicate the different primary particles, respectively. It is clearly observed that the Nb concentration on the surface of the primary particle is higher than the Nb concentration inside the primary particle.

CEX1 is a material which comprises Ni, Mn, Co, and Al, but does not comprise B and Nb. CEX3 is a material further comprising Nb in addition to the elements of CEX1. The discharge capacity at the first cycle (DQ1) of CEX3 is 228.7 mAh/g that is higher than the DQ1 of CEX1 having the value of 209.9 mAh/g. However, by comparing the capacity fading rate (QF), the electrochemical cell comprising CEX3 shows the worse stability having 41.2%/100 cycle as QF than the electrochemical cell comprising CEX1 having 28.1%/100 cycle as QF.

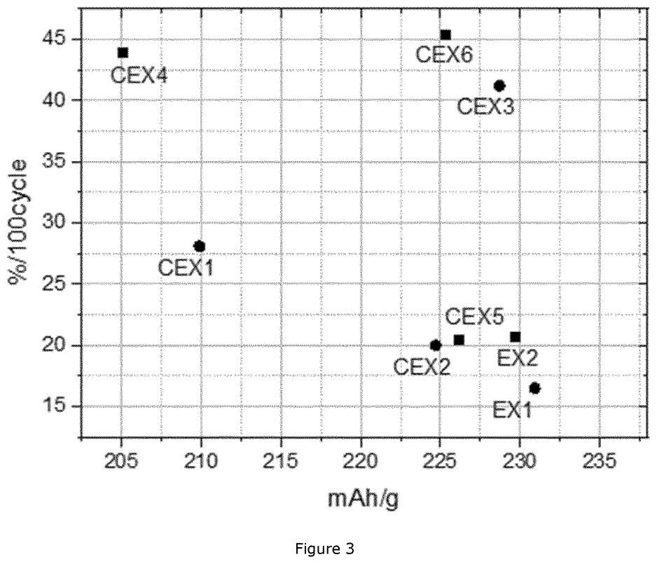

Referring to FIG. 3, when the experimental results of CEX1 and CEX3 are compared, QF is worsened due to Nb presence. Thus, Nb is not considered to be advantageous in view of the electrochemical stability. However, the experimental result of EX1 shows an unexpected synergistic effect that both QF and DQ1 are improved by comprising Nb, B coating and the mixing process with an aqueous solution. In detail, it is clearly observed that the electrochemical cell comprising EX1 has the highest DQ1 and the best electrochemical stability among EX1, CEX1, CEX2, and CEX3 where the DQ1 is 230.9 mAh/g and the QF is 16.5%/100 cycle. With respect to EX2, it is also observed that EX2 shows the highest DQ1 of 229.7 mAh/g among EX2, CEX4, CEX5, and CEX6, and the electrochemical stability having the QF of 20.7%/100 cycle, which is lower than those of CEX4 and CEX6, and similar to CEX5.

CEX7 is substantially identical to EX2 except that CEX7 does not comprise Al. The DQ1 and QF of CEX7 is quite comparable to those of EX2. However, Table 6 below showing the full cell results of the increased cell thickness after 20 hours in % and the DCR after 600 cycles for EX2 and CEX7 exhibits that EX2 has much improved full cell results than CEX7.

TABLE 6
The full cell results such as the increased cell thickness after
20 hours (%) and the DCR after 600 cycles for EX2 and CEX7

| Example | Increased cell thickness | DCR after 600 |
|---|---|---|
| ID | after 20 hours (%) | cycles (%) |
| EX2 | 34.3 | 114.3 |
| CEX7 | 54.1 | 128.8 |

In detail, the cell thickness of EX2 after 20 hours of the full cell cycling increased 34.3% which is lower than the increased cell thickness of CEX7, wherein the less increased cell thickness presents the lower incidentally produced gas during the cycle. The DCR of EX2 after 600 cycles is 114.3% which is lower than the DCR of CEX7. Thus, it is confirmed that QF, DQ1 and the above full cell test results are improved altogether when the positive electrode active material comprises Al, Nb, B coating and BET ranging from 0.50 m²/g to 1.50 m²/g, which may be obtained by mixing a lithiated transition metal composite material with an aqueous solution.

1-15. (canceled)

16. A positive electrode active material for lithium-ion rechargeable batteries, wherein the positive electrode active material comprises Li, M′, and oxygen, wherein M′ comprises:
Ni in a content x, wherein x≥80.0 at %, relative to M′;
Co in a content y, wherein 0.0≤y≤20.0 at %, relative to M′;
Mn in a content z, wherein 0.0≤z≤20.0 at %, relative to M′;
D in a content a, wherein 0.0<a≤5.0 at %, relative to M′, wherein D is at least one element selected from the group consisting of Ba, Ca, Cr, Fe, Mg, Mo, S, Si, Sr, Ti, Y, V, W, and Zn;
B in a content b, wherein 0.0<b≤4.0 at %, relative to M′;
Nb in a content c, wherein 0.0<c≤4.0 at %, relative to M′;
Al in a content d, wherein 0.0≤d<4.0 at %, relative to M′; and
Zr in a content e, wherein 0.0≤e≤4.0 at %, relative to M′,
wherein x, y, z, a, b, c, d, and e are measured by ICP-OES,
wherein x+y+z+a+b+c+d+e is 100.0 at %,
wherein the positive electrode active material has a B content B_{A} defined as b/(x+y+z+b+c+d+e), and wherein the positive electrode active material has a B content B_{B} wherein B_{B} is determined by XPS analysis and B_{B} is expressed as atomic content compared to the sum of atomic contents of Ni, Co, Mn, B, Nb, Al, and Zr as measured by XPS analysis, wherein a ratio B_{B}/B_{A}>10.0, and
wherein a specific surface area of said positive electrode active material is higher than or equal to 0.50 m²/g and lower than or equal to 1.50 m²/g.

17. The positive electrode active material according to claim 16, wherein e=0.0 at %, relative to M′.

18. The positive electrode active material according to claim 16, wherein the ratio B_{B}/B_{A} is at least 35.0.

19. The positive electrode active material according to claim 16, wherein the specific surface area of said positive electrode active material is between 0.60 m²/g and 1.40 m²/g.

20. The positive electrode active material according to claim 16, wherein the positive electrode active material comprises at least 100 ppm and at most 500 ppm carbon content as measured by carbon combustion method.

21. The positive electrode active material according to claim 16, comprising primary particles, wherein a concentration of Nb, relative to the sum of atomic contents of Ni, Mn, Co, and Nb, on a surface of the primary particles is higher than a concentration of Nb, relative to the sum of atomic contents of Ni, Mn, Co, and Nb, at a center of the primary particles, wherein the concentration of Nb is measured by cross-sectional STEM-EDS analysis.

22. The positive electrode active material according to claim 16, wherein x≥82.0 at %, relative to M′.

23. The positive electrode active material according to claim 16, wherein x≤99.0 at %, relative to M′.

24. The positive electrode active material according to claim 16, wherein y≤15.0 at %, relative to M′.

25. A method for manufacturing the positive electrode active material according to claim 16, wherein the method comprises the following consecutive steps of:
Step 1) mixing a Li source and a transition metal composite precursor comprising Ni, optionally Co and optionally Mn with a Nb-containing compound to obtain a first mixture;
Step 2) heating the first mixture at a temperature between 600° C. and 900° C. to obtain a first heated material;
Step 3) mixing the first heated material with an aqueous solution to obtain a slurry, filtering, and then drying said slurry to obtain a dried powder;
Step 4) mixing the dried powder with a B-containing compound to obtain a second mixture; and
Step 5) heating the second mixture at a temperature between 250° C. and 500° C. so as to obtain the positive electrode active material powder.

26. The method according to claim 25, wherein the second mixture is heated at a temperature between 250° C. and 450° C.

27. The method according to claim 25, wherein the Nb-containing compound in Step 1) is at least one selected from the group consisting of niobium acid, niobium oxide, and lithium niobium oxide.

28. The method according to claim 25, wherein the B-containing compound in Step 4) is at least one selected from the group consisting of boric acid, boron oxide, and lithium boron oxide.

29. A battery comprising the positive electrode active material according to claim 16.
